(19) United States
(12) Patent Application Publication
(10) Pub. No.: US 2022/0374628 A1
(43) Pub. Date: Nov. 24, 2022

(54) CAMERA TAMPERING DETECTION

(71) Applicant: Ford Global Technologies, LLC, Dearborn, MI (US)

(72) Inventors: Ali Hassani, Ann Arbor, MI (US); Hafiz Malik, Canton, MI (US); Jonathan Diedrich, Carleton, MI (US)

(73) Assignee: Ford Global Technologies, LLC, Dearborn, MI (US)

(21) Appl. No.: 17/326,581

(22) Filed: May 21, 2021

(51) Int. Cl. G06K 9/00; G06T 7/66; B60R 25/30; B60R 25/25; B60R 25/01

(52) U.S. Cl. CPC G06K 9/00288; G06T 7/66; G06K 9/00899; B60R 25/305; B60R 25/25; B60R 25/01

(57) ABSTRACT

A computer, including a processor and a memory, the memory including instructions to be executed by the processor to determine a center of an object in a first image acquired by a camera, determine camera nise values for a zone in the first image that includes the center and determine a fakeness score by comparing the camera noise values with previously determined camera noise values.

### BACKGROUND

Computer-based operations performed on image data can depend upon having a verified source of image data for successful operation. Computer-based security operations include facial recognition, a type of biometric authentication where an image of a human face is used to determine an identity of a person seeking access to a vehicle, building or device, such as a computer or smart phone. Computer-based vehicle operation can include a computing device in a vehicle acquiring image data from sensors included in the vehicle and processing the image data to determine a vehicle path upon which to operate the vehicle. Successful performance of computer-based image processing operations can depend upon verifying the source of image data.

### BRIEF DESCRIPTION OF THE DRAWINGS

FIG. 1 is a diagram of an example vehicle.

FIG. 2 is a diagram of an example photo response non-uniformity processing.

FIG. 3 is a diagram of an example image with zones.

FIG. 4 is a diagram of an example image with a human face detected.

FIG. 5 is a diagram of an example image with a single zone selected.

FIG. 6 is a flowchart diagram of an example process to determine camera tampering.

### DETAILED DESCRIPTION

Computer-based operations performed on image data can depend upon having a verified source of image data for successful operation. Successful operation is operation of a computer-based system that achieves the design goals of the syste. For example, a biometric authorization system should permit authorized people access and deny access to unauthorized people. An autonomous vehicle system should operate a vehicle without contacting other vehicles or objects such as buildings. Successful operation of security tasks such as biometric authorization and vehicle tasks such as autonomous or semi-autonomous operation can depend upon verifying that the image data being process was acquired by a specific camera. For example, an unauthorized user can attempt to gain access to a vehicle, building, or device by substituting an image of an authorized user from a different source than the camera included in the security system. In another example, an autonomous vehicle could be forced to travel to an unauthorized location by substituting images of a different location for the images being acquired by the vehicle's cameras. Techniques discussed herein can permit successful operation of computer-based image processing systems by detecting camera tampering, where camera tampering means unauthorized substitution of camera hardware or image data.

Biometric authentication can be used to control access to buildings, homes, or vehicles, and can be used to grant permission to operate computers, cell phones, or other devices. Biometric authentication software can be executed on a computing device included in the location or device being accessed, or the image data can be uploaded to a cloud-based server that maintains a database of trained models for execution. An example of biometric authentication software is facial identification software, for example Face Tracker. Face Tracker is a facial recognition software library written in C++ and available on facetracker.net under the MIT software license. Biometric authentication software can be executed on a computing device included in the location or device being accessed, or the image data can be uploaded to a cloud-based server that maintains a database of trained models for execution. The results of performing the biometric authentication can be downloaded to the device seeking authentication and permission to access a vehicle, vehicle controls, an area including a building or a room or a device including a computer or a cell phone can be granted or denied.

Biometric facial recognition typically operates by calculating physiological characteristics of a human face and comparing the calculated physiological characteristics to stored physiological characteristics from the trained model. Physiological characteristics can include measures of facial features such as the distance between pupils, distance between corners of the mouth and length of nose, etc. These measures can be normalized by forming ratios of the measurements and stored as the trained model. At challenge time, an image of the human seeking access is acquired and processed to extract physiological characteristics which are then compared to stored physiological characteristics to determine a match. Successful authentication can be used to unlock a vehicle door or enable vehicle controls. In other examples, successful authentication can be used for security applications such as access to a location or room by unlocking a door, or yet further alternatively or additionally access to a device such as a computer by enabling input devices like a keyboard or mouse or granting access to files.

As biometric authentication technology has advanced, techniques for tampering with camera data to fool a biometric authentication system into authenticating a deceptive fake (spoofing) have advanced also. For example, neural networks can be used to generate “deep fake” images and videos, where one person's likeness can be edited onto another person's body, a person's appearance can be transplanted into a scene they have never inhabited made, or a person can be made to appear as if they were speaking words they never spoke in real life. Counterfeit images determined based on skilled manual image processing or deep fake technology can spoof a biometric authorization system based on facial recognition and thereby grant access to an unauthorized person to access to a vehicle, vehicle controls, a building, a computing device or a cell phone.

A vehicle can be operable in autonomous (“autonomous” by itself in this disclosure means “fully autonomous”), semi-autonomous, and occupant piloted (also referred to as non-autonomous) mode. A computing devices in a vehicle can receive image data regarding the operation of the vehicle from vehicle sensors including cameras. The computing device may operate the vehicle in an autonomous mode, a semi-autonomous mode, or a non-autonomous mode based on processing image data acquired by vehicle sensors including cameras. A computing device in a vehicle can use image data to detect objects such as other vehicles, pedestrians, traffic signs or barriers, etc. in an environment around the vehicle. Image processing software included in the computing device can depend upon receiving that includes expected pixel intensities for correct operation of the image processing software. Camera tampering such as nauthroized substitution of a different camera for an expected camera or substituting video data from another source can cause the image processing software to arrive at an incorrect result, e.g., not detecting a pedestrian in a field of view of the camera, for example. Detecting camera tampering can detect unauthorized data being introduced into a vehicle operation system.

Techniques discussed herein detect camera tampering by identifying deviations from an intrinsic property of image data acquired by a given camera. An intrinsic property of the image data includes distributions of noise in the image data. Techniques discussed herein can detect visually deceptive fakes while advantageously using computing resources efficiently enough to run in real time on vehicle computing systems. Techniques discussed herein use camera noise characterization to create a binary classification of untampered versus tampered images. Relevant noise distribution can be determined based on photo response non-uniformity (PRNU), for example. PRNU can be used to create an expected noise “fingerprint” for identification of an image that includes a particular person. While machine learning faking algorithms can become visually deceptive, the noise “fingerprint” remains intrinsic to the imager and a portion of the image that includes the person's face. Techniques discussed herein improve vehicle biometric authentication by detecting camera tampering, in particular camera tampering that includes a counterfeit image of a person.

Another technique for determining a camera noise “fingerprint” is to measure camera dark current noise. Camera dark current noise is a measure of the amount of current generated by a camera photosite in the absence of any light stimulation falling on the photosite. A photosite is the portion of a camera sensor that converts incoming light to electrical current. Dark current noise is thermal noise resulting from electrons spontaneously generated within the camera sensor caused by valence electrons being thermally excited into the conduction band. The variation in the number of dark electrons collected during an exposure is the dark current noise. Dark current noise is independent of the signal level but is dependent on the temperature of the sensor. Each photosite included in a sensor can have a characteristic level of dark current noise which can be combined to identify a particular camera.

Camera dark current noise data can be acquired by masking off a small number of sensor photosites, typically along one or more edges of the sensor to ensure that no light will fall on the photosites. When an image from the camera is acquired, the masked off photosites will show up in the image as dark pixels. By acquiring a long exposure image, sufficient thermal electrons will be generated in the masked off portions of the image to permit measurement of the dark current noise. Because thermal electrons obey Poisson statistics, the dark current noise corresponding to the current generated by the thermal electrons is the square root of the pixel value. The current generated by the thermal electrons is also a function of temperature so the temperature of the sensor can be measured to determine a temperature factor to be multiplied times the pixel values to compensate for temperature. The resulting dark current noise values for the masked off pixels can be combined to be compared to subsequently acquired dark current noise values or retained as an array of pixels to be correlated with subsequently acquired dark current noise values.

A counterfeit image of a person can be made by obtaining an image of a person authorized to access a vehicle from a different camera source other than a camera included in the vehicle. Presentation of counterfeit images to a biometric authorization system can be referred to in this context at camera tampering. Techniques discussed herein can improve biometric authorization systems by determining one or more distributions of image noise in a portion of an image that includes a human face to determine camera tampering. For example, when camera tampering is detected, techniques discussed herein will prevent image data from being output for use in biometric authentication. Techniques disclosed herein can also determine a fakeness score which indicates a probability that the image presented to the biometric authorization system was acquired by the same camera as was previously used to acquire the enrollment image. The fakeness score can be multiplied by a score output from a subsequent biometric authentication system to determine an overall probability that person in the challenge image corresponds to the same person in the enrollment image.

Techniques discussed herein can determine camera tampering by processing images from a camera to determine one or more distributions of camera noise values for a region of an image and comparing the distributions of camera noise values to previously determined distributions of camera noise values based on a previously acquired image from the same camera. As discussed above, camera noise can be measured by PRNU or dark current noise. PRNU measures a camera's fixed pattern noise, where pattern point noise is a measure of the response of a pixel to a uniform light stimulus. PRNU can be determined for each pixel corresponding to a photoreceptor in the camera. The photoreceptor can be optically filtered using a red, green, or blue mosaic filter or can be a visible light or near infrared grayscale pixel. Existing techniques for detecting camera tampering include machine learning techniques or data driven techniques. Machine learning techniques can detect camera tampering by analyzing images to detect blurriness on the edges of tampered regions using deep neural networks trained for that purpose, for example. Data driven techniques form databases of tampered images and try to detect camera tampering by matching images to images in the database of tampered images. PRNU distribution comparison can be a more reliable measure of camera tampering than either machine learning techniques or data driven techniques. PRNU or dark current matching matching can also be determined using fewer computing resources than either machine learning techniques or data driven techniques.

Vehicles, buildings and devices can be equipped with computing devices, networks, sensors, and controllers to acquire and/or process data regarding the environment and to permit access to the vehicle based on the data. For example, a camera in a vehicle or building can be programmed to acquire an image of an approaching user and, upon determining the identity of the user based on facial recognition software, unlock a door to permit the user to enter. Likewise, cameras included in the interior of a vehicle or a device can acquire one or more images of a user and, upon determining the identity of the user based on facial recognition software, accept commands from the human to operate the vehicle or device.

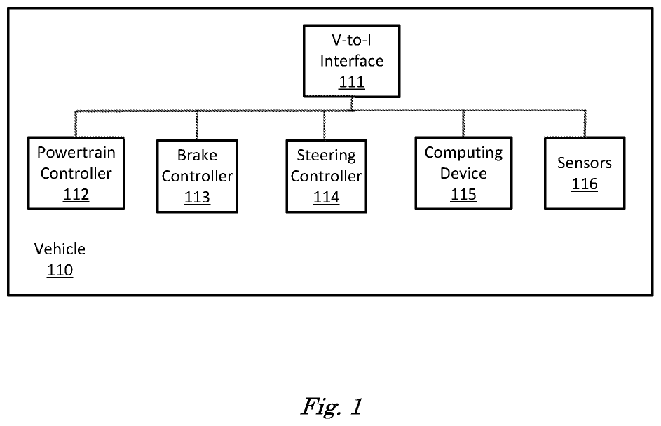

FIG. 1 is a diagram of a vehicle 110 including a computing device 115 and sensors 116. The computing device (or computer) 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer, e.g., a cloud server, via a network, which, as described below, includes hardware, firmware, and software that permits computing device 115 to communicate with a remote server computer via a network such as wireless Internet (WI-FI®) or cellular networks. V-to-I interface 111 may accordingly include processors, memory, transceivers, etc., configured to utilize various wired and/or wireless networking technologies, e.g., cellular, BLUETOOTH®, Ultra-Wide Band (UWB),® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V-to-I) interface 111 to a server computer or user mobile device.

As already mentioned, generally included in instructions stored in the memory and executable by the processor of the computing device 115 is programming for operating one or more vehicle 110 components, e.g., braking, steering, propulsion, etc. Using data received in the computing device 115, e.g., the sensor data from the sensors 116, the server computer, etc., the computing device 115 may make various determinations and/or control various vehicle 110 components and/or operations. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to share data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110.

The vehicle 110 is generally a land-based vehicle 110 capable of operation and having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, lidar, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

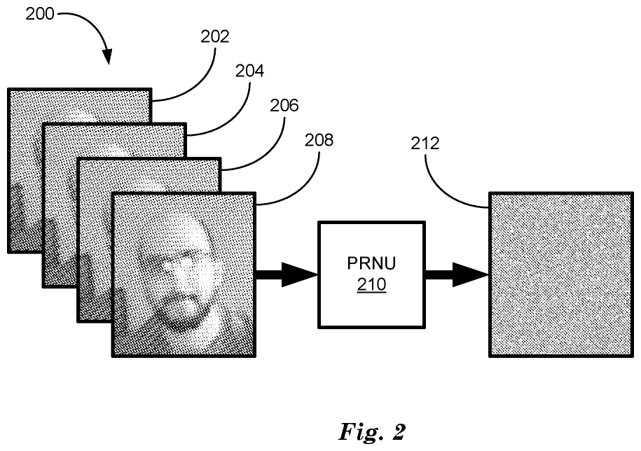

FIG. 2 is a diagram of example PRNU determination. PRNU for image data can be determined based on image data acquired by the sensors 116 included in a vehicle, a building, or a device such as a computer or a cell phone and communicated to a computing device 115 for processing. One or more images 200 can be acquired from an image sensor 116; in the example of FIG. 2 there are four images 202, 204, 206, 208, acquired by sensors 116 included in a vehicle and input to PRNU block 210, which can be a software program executing on computing device 115. PRNU block 210 determines an unbiased estimator \hat{K} for each pixel location in the input one or more images 200 according to the equation:

$$\hat{K} = \frac{{Σ}_{i}^{m} {W}_{i} {I}_{i}}{{{Σ}_{i}^{m} ( {I}_{i} )}^{2}} \qquad ( 1 )$$

Where Iᵢ is a pixel value of the i-th image and Wᵢ is noise residual of the i-th image determined by filtering the i-th image with a de-noising filter, such as a wavelet filter or a smoothing filter to form a filtered image Iᵢ⁽⁰⁾ and then subtracting the filtered image Iᵢ⁽⁰⁾ from the unfiltered image Iᵢ to form the noise residual Wᵢ=Iᵢ−Iᵢ⁽⁰⁾. PRNU is calculated by first determining the difference between each pixel value in each of the one or more images 200 and the unbiased estimator \hat{K} for each pixel location. Statistics based on the distributions of difference values can be determined for each pixel location common to the one or more images 200, thereby determining one or more new images with the same dimensions as the one or more images 200 for each statistical measure applied to the difference values.

Images of PRNU values can include measures of mean, variance, skewness, and kurtosis for each pixel location based on the distributions of differences between pixel values and the unbiased estimator \hat{K}. The first measure of PRNU value is the mean value of differences between the pixel values and the unbiased estimator \hat{K} for each pixel location. The second measure is the first moment about the mean or variance. Variance is a measure of the width of a distribution about a mean. The third measure is skewness. Skewness is a measure of how symmetric the distribution is about the mean. The fourth measure is kurtosis. Kurtosis is a measure of how flat or peaked a distribution is. One to four PRNU images can be determined based on how much precision is required in the counterfeit detection process. For example, PRNU values corresponding to the mean and variance could be used to detect an image of a photograph of a human face from a real image of a human face. Four PRNU images including skewness and kurtosis can be required to detect an image of the correct real human face acquired with a different make and model of camera.

PRNU block 210 outputs the one or more PRNU images corresponding to the mean, variance skewness and kurtosis. Mean, variance, skewness, and kurtosis can also be calculated for each color in a red, green, blue (RGB) color image or grayscale image. Correct calculation of the mean, variance, skewness and kurtosis should be performed on the raw pixel data without averaging or combining pixels. Calculating PRNU values for variance, skewness, and kurtosis for each color in an RGB image can yield twelve output images from PRNU block 210. An advantage of calculating PRNU values using unbiased estimator \hat{K} is that PRNU values can be determined without having to present one or more predetermined targets, such as sinusoidal patterns at predetermined lighting levels to a camera to calculate the PRNU values. PRNU values are measures of fixed point noise in an image, where fixed point noise is the variation in pixel values from one image to the next at a particular location in an image determined by acquiring more than one image of the same scene. Mean, variance, skewness, and kurtosis can also be determined for camera dark current noise and the same techniques for comparing PRNU values can be used to compare camera dark current noise statistics.

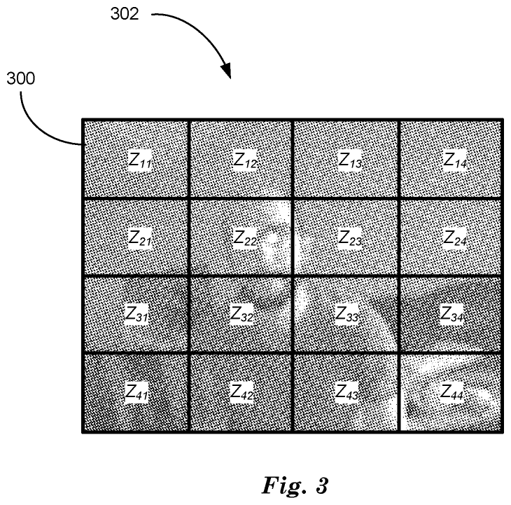

FIG. 3 is a diagram of an example image 300 acquired by a camera included in a vehicle 110 and communicated to a computing device 115. Image 300 is shown rendered in grayscale to comply with Patent Office regulations but could be a grayscale image or an RGB image. Image 300 can be divided into zones Z_{rc} 302 and PRNU values calculated for zones Z_{rc} 302 that include objects of interest, for example a human face. Calculating PRNU values for zones Z_{rc} 302 that include a human face can identify both the camera that acquired the image and the human face in the image. Both the camera and the human face introduce fixed pattern noise that can be determined by PRNU values including mean, variance, skewness, and kurtosis of the distributions of fixed point noise for the pixels in an image. Comparing PRNU values to previously acquired PRNU values can determine whether the human face in a current image is the same human face in an image previously acquired by the same camera. PRNU values can be compared by correlating the PRNU values with previously acquired PRNU values to determine a correlation coefficient. Up to four PRNU values can be determined for one or more grayscale images. In examples where four PRNU values are determined for each of the red, green, or blue channels of an RGB color image, up to 12 PRNU values can be determined

Following calculation of the up to 12 images that include PRNU values, the images that include PRNU values can be compared to images of PRNU values obtained at enrollment time using correlation. Enrollment in this context refers to determining a camera noise profile by calculating PRNU values for a given camera. The enrollment PRNU values can be compared to challenge PRNU values obtained at a later time to determine camera tampering by correlation of the two sets of PRNU values. Correlation is an operation that multiplies each number of a first image times each number of a second image and sums while moving the first image center with respect to the second image center. Following the multiplications and summations the maximum value can be normalized and selected as the correlation coefficient. The one or more correlations coefficients can be averaged to determine an overall correlation coefficient ρ. A fakeness score F can be determined by according to the calculation:

F=1−α×ρ(enrollment, challenge) (2)

Where enrollment includes the images that include the PRNU values from the enrollment images and challenge includes the images that include the PRNU values from the challenge images. ρ( ) is the correlation function discussed above and α is a scalar constant that can be determined empirically by acquiring and testing a plurality of real and counterfeit images.

Determination of camera tampering by calculating a fakeness score F for an image from a camera can be improved by reducing the resolution of the image. Resolution of an image can be reduced without reducing the accuracy of the fakeness score F by forming a reduced resolution image by performing ½ by ½ down sampling of the image by using every other pixel in the x and y direction. This results in an image with ¼ the number of pixels, thereby reducing the number of calculations required to determine the fakeness score F by a factor of four. Depending upon the amount of image noise present, an image can be down sampled to 1/16 of the original number of pixels (¼ down sampling) without changing the fakeness score F. The amount of down sampling to use can be determined empirically by comparing down sampled fakeness scores F for original images vs. down sampled images to determine which level of down sampling to employ for a given camera. Techniques discussed herein can improve camera tampering detection by down sampling image data to reduce computing time and resources required to calculate fakeness scores F.

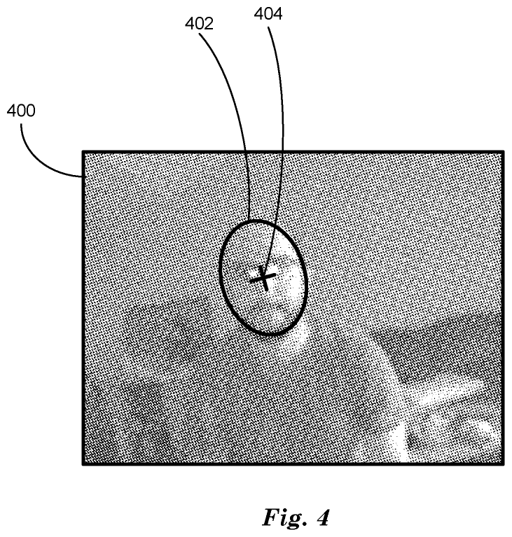

FIG. 4 is a diagram of an image 400 acquired by a camera included in a vehicle 110 and communicated to a computing device 115. Image 400 is shown rendered in grayscale to comply with Patent Office regulations but could be a grayscale image or an RGB image. Techniques discussed herein can detect counterfeit images by first using image processing software to detect the outline of a human face 402 in an image 400. Image processing software that can determine an outline of a human face 402 is included in Dlib, a toolkit containing machine learning algorithms and tools for creating complex software in C++. Dlib is available at Github.com and is available on an open source license which permits its use free of charge. Dlib includes a routine called Get_Frontal_Face_Detector which is a routine that is configured to find a human face that is looking more or less towards a camera. A computing device 115 executing a routine such as Get_Frontal_Face_Detector can detect an outline of a human face 402 along with the center 404 of the face in an image 400.

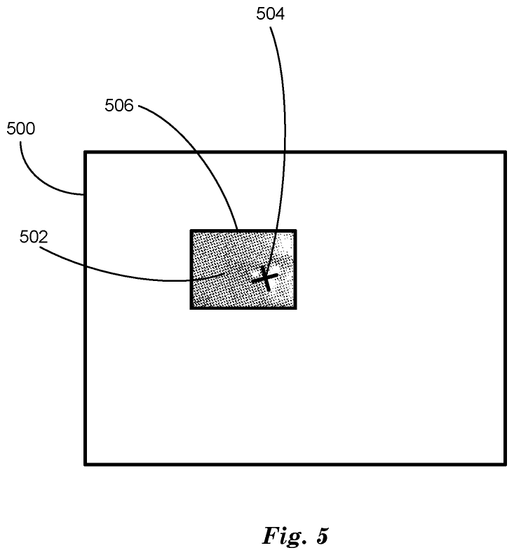

FIG. 5 is a diagram of an image 500 acquired by a camera included in a vehicle 110 and communicated to a computing device 115. Image 500 is shown rendered in grayscale to comply with Patent Office regulations but could be a grayscale image or an RGB image. Image 500 has been masked by determining a center 504 of a human face 502 included in image 500 and detected using a routine such as Get_Frontal_Face_Detector described above in relation to FIG. 4. Computing device 115 can mask image 500 by determining a zone Z_{rc} 506 that includes the center 504 of a human face 502 and setting all pixel values outside of zone Z_{rc} 506 to zero. A fakeness score F for image 500 can be determined by calculating camera noise scores on pixels within zone Z_{rc} 506. The camera noise scores can be correlated with camera noise scores determined based on processing an enrollment image processed as described in relation to FIGS. 4 and 5 to include only pixels corresponding to a center or a human face and a zone Z, that includes the center of the human face.

Following determination of a fakeness score F for an image 500, the image 500 can be passed to a biometric authorization system executing on a computing device 115. The biometric authorization routine can include facial identification software. Facial identification software can determine two sets of facial features corresponding to a challenge image and an enrollment image and determine ratios of distances between features. Facial identification software can determine a facial identification score by determining a match value with previously determined facial identification features. The facial identification score can be combined with a fakeness score to determine a fakness confidence score. A user authentication status can be determined by comparing the fakeness confidence score to a threshold. The threshold can be determined empirically by acquiring a plurality of real and fake images 500, determining fakesness scores F and facial identification scores for the real and fake images 500 and determining a threshold based on the fakeness confidence scores for the plurality of real and fake images 500.

Facial features include locations on a facial image such as inner and outer corners of the eyes and corners of the mouth. For example, facial feature detection routines such as SURF in the Dlib image processing library can determine locations on a face corresponding to facial features such as the center of each eye and the center of a mouth. The facial identification software can compare the ratios based on the two sets of features and determine a match value. If the ratios between sets of features match, meaning that they have the same value within an empirically determined tolerance, the person in the challenge image is determined to be the same person as in the previously acquired enrollment image. A match value can be determined by determining a mean squared difference between the two sets of ratios. Matching the ratios of distances can reduce the variance in facial feature measurements caused by differences due to differences in distances from the camera and differences in poses between the two images. A facial identification score can be determined using an equation similar to equation (2), above, substituting the match value for the correlation function and determining a value for α that maps the match score to the interval (0,1), with values close to 1 corresponding to a good match and values close to 0 corresponding to a poor match.

A fakeness confidence score for biometric authorization can be determined by multiplying the fakeness score by the facial identification score. A fakeness confidence score can be used to determine a user authentication status. A fakeness confidence score greater than a threshold can indicate that the challenge image was likely not a counterfeit and the challenge was a good match for the enrollment image, therefore the user authentication status should be “authenticated” and access to a vehicle, building, or device can be granted to the user. A fakeness confidence score less than the threshold can indicate that either the challenge image was likely a counterfeit or that the facial identification score indicated that the challenge image did not match the enrollment image or both, and therefore user authentication status should be set to “not authenticated” and access to the vehicle, building or device should not be granted to the user. A fakeness confidence score less than the threshold can indicate problems with either the fakeness score or facial identification score, i.e., a counterfeit image passed facial identification, or a real image failed facial identification. In either case access to the vehicle, area, or computer should be denied. An example threshold for determining a successful fakeness confidence score in one example is 0.5, and in general can be determined empirically based on testing the system with a plurality of real and counterfeit images.

Combining fakeness scores and facial identification scores to determine a fakeness confidence score as described herein can improve biometric authorization by detecting counterfeit images that can successfully pass biometric authorization. Determining a fakeness score based on a single image zone that includes the center of a human face permits the fakeness score to be determined with far fewer computer resources than previous techniques that require processing an entire image to determine camera tampering.

A fakeness score F can also be used to determine camera tampering for an image 500 used operate a vehicle 110. As discussed above in relation to FIG. 1, an image 500 from a camera included in a vehicle 110 can be used by a computing device 115 to operate the vehicle 110. Camera tampering can cause image processing software included in a computing device 115 to output an erroneous result. For example, changing a camera in a vehicle for a different camera with a different resolution and response to light can cause pixel values corresponding to objects in images to change enough to prevent image processing software from detecting the objects. In other examples image data from a different camera can be substituted for image data from an original camera for nefarious purposes, for example to cause a vehicle 110 to contact an object. Detecting camera tampering by determining a fakeness score F can prevent erroneous operation of a vehicle 110 due to camera tampering.

The techniques discussed herein regarding camera tampering detection can be subject to reinforcement learning. Reinforcement learning is performed by keeping statistics regarding the number of correct and incorrect results achieved by a camera tampering detection system in use and using the statistical results to re-train the camera tampering detection system. For example, assume a camera tampering detection system is used as input to a biometric authorization system used to unlock a vehicle, building, or device when approached by a valid user. A valid user is a user with prearranged permission to use the vehicle, building, or device. In an example where the camera tampering detection system fails to correctly verify a camera and unlock the vehicle, the user can be forced to unlock the vehicle manually with a key or fob, or use a 2-factor authorization system such as entering a code sent to a cell phone number. When a user is forced to unlock the vehicle manually, the camera tampering detection system can store data regarding the incorrect camera source data including the image of the user.

Determining what to do with data regarding the incorrect camera tampering detection can be based on a reward system. A reward system retrains the camera tampering detection system corresponding to the camera tampering detection data depending upon the outcome of the failure to authenticate. If the potential user fails to gain access to the vehicle, it is assumed that the failed attempt was an attempted spoof, and the data is appended to a training dataset of likely spoof data. If the potential user gains access using one of the manual approaches, for example keys, fobs, or 2-factor authorization, the data is appended to a training dataset of false negatives to be corrected in the training process. The authentication system can be retrained based on the updated training dataset periodically or when the number of new camera tampering detection datasets added to the training dataset exceeds a user-determined threshold. Retraining can be applied to both deterministic authentication systems based on Gaussian parameters and deep neural network-based systems.

Data regarding failure to verify camera tampering can be federated or shared among a plurality of vehicles. The data regarding failure to verify camera tampering can be uploaded to a cloud-based server that includes a central repository of training datasets. The uploaded verify a camera source datasets and corresponding outcomes can be aggregated in updated training datasets and results of retraining based on the new data can be compared to results for the previous training. If the new training dataset improves performance, the new trained model can be pushed or downloaded to vehicles using the camera tampering detection system. Note that no personal data regarding users' identities needs to be uploaded to the cloud-based servers, only camera source verification datasets and outcomes. By federating new trained models based on training data uploaded from a plurality of locations, performance of a camera tampering detection system can be continuously improved over the lifetime of the system.

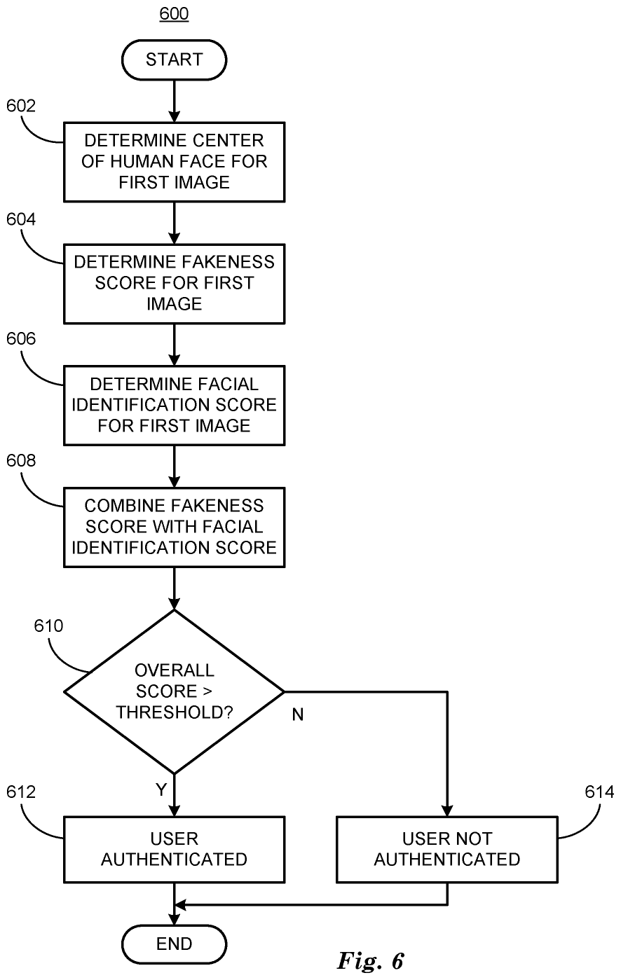

FIG. 6 is a diagram of a flowchart, described in relation to FIGS. 1-4, of a process 600 for detecting counterfeit images. Process 600 can be implemented by a processor of a computing device such as a computing device 115, taking as input information from sensors, and executing commands, and outputting object information, for example. Process 600 includes multiple blocks that can be executed in the illustrated order. Process 600 could alternatively or additionally include fewer blocks or can include the blocks executed in different orders.

Process 600 begins at block 602, where a computing device 115 determines a center of an object in a first image acquired by a camera included in a vehicle 110. The object can be a human face and the computing device 115 can locate the center of the human face and determine an image zone that includes the object center as discussed above in relation to FIGS. 3 and 4.

At block 604 the computing device 115 determines a fakeness score for a zone in the first image that includes the center of the human face determined at block 602. The fakeness score can be determined by determining camera noise values for the first or challenge image as discussed above in relation to FIG. 2, and then correlating the determined camera noise values with stored camera noise values for a second or enrollment image that was previously acquired using the same camera that acquired the first image, as discussed above in relation to FIG. 5.

At block 606 the computing device 115 the computing device 115 processes the first or challenge image to determine a facial identification score by extracting facial features from the first or challenge image and comparing the facial features to previously determined facial features from an enrollment image using facial identification software as discussed above with relation to FIG. 5.

At block 608 the computing device 115 can combine the fakeness score with the facial identification score by multiplying them to determine a fakeness confidence score.

At block 610 the computing device 115 compares the overall score to a threshold to determine whether the user authentication status should be set to authenticated or not authenticated. When the overall score is greater than the threshold, the user authentication status is authenticated and process 600 passes to block 612. When the overall score is less than or equal to the threshold, the user authentication status is not authenticated and process 600 passes to block 614.

At block 612 the overall score is greater than the threshold, the first or challenge image can be determined to be legitimate, i.e., not counterfeit, because the human face in the first or challenge image matches the human face in the enrollment image. The user authentication status is therefore authenticated and user access is granted to the vehicle, vehicle controls, building, room, or device being protected by the biometric authentication system. Following block 612, process 600 ends.

At block 614, the overall score is less than or equal to the threshold, the first or challenge image is likely a counterfeit or the human face in the first or challenge image does not match the human face in the enrollment image, or both. The user authentication status is therefore not authenticated and user access is not granted to the vehicle, vehicle controls, building, room, or device being protected by the biometric authentication system. Following block 614, process 600 ends

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A computer, comprising:
a processor; and
a memory, the memory including instructions executable by the processor to:
determine a center of an object in a first image acquired by a camera;
determine camera noise values for a zone in the first image that includes the center; and
determine a fakeness score by comparing the camera noise values with previously determined camera noise values.

2. The computer of claim 1, the instructions including further instructions to:
determine a facial identification score by determining a match value with previously determined facial identification features;
combine the fakeness score with the facial identification score to determine a fakeness confidence score; and
determine a user authentication status by comparing the fakeness confidence score to a threshold.

3. The computer of claim 2, the instructions including further instructions to, when the user authentication status is authenticated, grant access to at least one of a vehicle, a vehicle control, an area including a building or a room or a device including a computer or a cell phone.

4. The computer of claim 1, the instructions including further instructions to operate a vehicle based on the fakeness score.

5. The computer of claim 1, the instructions including further instructions to determine the previously determined camera noise values by processing a previously acquired image of the object.

6. The computer of claim 1, the instructions including further instructions to determine the fakeness score by correlating the camera noise values for the zone in the first image with previously determined camera noise values.

7. The computer of claim 1, the instructions including further instructions to determine the previously determined camera noise values by processing a second image acquired by the camera that includes the object.

8. The computer of claim 1, the instructions including further instructions to determine the camera noise values as photo response non-uniformity including a value \hat{K} that is determined by the equation \hat{K}=Σᵢ₌₁^{m} WᵢIᵢ/Σᵢ₌₁^{m}(Iᵢ)² where Iᵢ is the i-th image acquired by the camera and Wᵢ is the noise residual of the i-th image.

9. The computer of claim 1, the instructions including further instructions to determine the camera noise values as dark current noise.

10. The computer of claim 1, wherein the camera noise values include one or more of mean, variance, skewness, and kurtosis.

11. The computer of claim 1, wherein the camera noise values include one or more of camera noise values for red, green, or blue channels of the first image.

12. The computer of claim 1, the instructions including further instructions to determine the center of the object with image processing software to detect an outline of a human face.

13. The computer of claim 1, the instructions including further instructions to determine the camera noise values in a zone that includes the center of the object.

14. A method comprising:
determining a center of an object in a first image acquired by a camera;
determining camera noise values for a zone in the first image that includes the center; and
determining a fakeness score by comparing the camera noise values with previously determined camera noise values.

15. The method of claim 14, further comprising:
determining a facial identification score by determining a match value with previously determined facial identification features;
combine the fakeness score with the facial identification score to determine a fakeness confidence score; and
determine a user authentication status by comparing the fakeness confidence score to a threshold.

16. The method of claim 15, the instructions including further instructions to, when the user authentication status is authenticated, grant access to at least one of a vehicle, a vehicle control, an area including a building or a room or a device including a computer or a cell phone.

17. The method of claim 14, the instructions including further instructions to operate a vehicle based on the fakeness score.

18. The method of claim 14, further comprising determining the previously determined camera noise values by processing a previously acquired image of the object.

19. The method of claim 14, further comprising determining the fakeness score by correlating the camera noise values for the zone in the first image with previously determined camera noise values.

20. The method of claim 14, further comprising determining the previously determined camera noise values by processing a second image acquired by the camera that includes the object.
